(19) United States
(12) Patent Application Publication
(10) Pub. No.: US 2026/0351751 A1
(43) Pub. Date: Nov. 5, 2026

(54) BATTERY CELL AND METHOD OF MANUFACTURING FOR THE SAME

(71) Applicant: SK On Co., Ltd., Seoul (KR)

(72) Inventors: Jae Hyun JEON, Daejeon (KR); Jun Ho JANG, Daejeon (KR); Jun Hui JEONG, Daejeon (KR); Eun Soo CHO, Daejeon (KR)

(21) Appl. No.: 19/665,872

(22) Filed: May 1, 2026

(30) Foreign Application Priority Data
May 2, 2025 (KR) 10-2025-0058381
Mar. 4, 2026 (KR) 10-2026-0039320

(51) Int. Cl. H01M 50/186; H01M 10/0585; H01M 50/105; H01M 50/119; H01M 50/129; H01M 50/178; H01M 50/19

(52) U.S. Cl. CPC H01M 50/186; H01M 10/0585; H01M 50/105; H01M 50/119; H01M 50/129; H01M 50/178; H01M 50/19

(57) ABSTRACT

Disclosed are a battery cell and a method of manufacturing the same. According to an embodiment of the present disclosure, a battery cell includes: an electrode assembly including at least one electrode tab; a cell pouch configured to accommodate the electrode assembly such that the electrode tab is led out to the outside through a sealing portion; and an insulator configured to cover at least a portion of the sealing portion, wherein the insulator includes a first insulator in a region where the electrode tab is led out, and a second insulator in a remaining region excluding the first insulator, and the insulator wraps around and is in contact with at least a portion of the sealing portion while facing the sealing portion.

### CROSS-REFERENCE TO RELATED PATENT APPLICATION

The present application claims priority under 35 U.S.C. § 119(a) to Korean patent application number 10-2025-0058381 filed on May 2, 2025 and Korean patent application number 10-2026-0039320 filed on Mar. 4, 2026, in the Ministry of Intellectual Property, the entire disclosure of which is incorporated by reference herein.

### BACKGROUND OF THE INVENTION

### 1. Field

The present disclosure relates to a battery cell and a method of manufacturing the same.

### 2. Description of the Related Art

The demand for secondary batteries as an energy power source to drive various electronic devices such as smartphones, laptops, vehicles, and drones is rapidly increasing. In particular, research on battery cells as secondary batteries for driving vehicles is actively being conducted.

Battery cells applied to electric vehicles and the like can be modularized by electrically connecting a plurality of battery cells due to the need for high power and large capacity, and an electric vehicle can be equipped with a battery module including a plurality of such battery cells to obtain high power.

For example, when a plurality of battery cells are connected in series/parallel to form a battery module, a battery module including at least one battery cell can be formed, and other components can be added using this at least one battery module to form a battery pack.

Generally, such a battery cell may include a case housing an electrode assembly, electrode tabs protruding from the case at front and rear ends thereof, and a cell pouch formed on the periphery of the case.

For example, the cell pouch may include a predetermined metal layer, and the metal layer may be exposed at an end of the cell pouch. If an electrical connection occurs between the exposed metal layer of the cell pouch and the electrode tabs, the cell pouch may be subjected to an electrical potential, which may cause the cell pouch to corrode and reduce the lifetime of the battery cell.

Therefore, there is a need to develop a battery cell and a manufacturing method thereof that can prevent an electrical connection between the metal layer of the cell pouch and the electrode tabs.

### SUMMARY OF THE INVENTION

An aspect of the present disclosure is to provide a battery cell having improved insulation performance, and a method of manufacturing the same.

Another aspect of the present disclosure is to provide a battery cell having improved durability, and a method of manufacturing the same.

Still another aspect of the present disclosure is to improve process efficiency in a method of manufacturing a battery cell.

To achieve the aforementioned technical aspects, the present disclosure may provide a battery cell and a method of manufacturing the same.

According to an embodiment of the present disclosure, a battery cell includes: an electrode assembly including at least one electrode tab; a cell pouch configured to accommodate the electrode assembly such that the electrode tab is led out to the outside through a sealing portion; and an insulator configured to cover at least a portion of the sealing portion, wherein the insulator includes a first insulator in a region where the electrode tab is led out, and a second insulator in a remaining region excluding the first insulator, and the insulator wraps around and is in contact with at least a portion of the sealing portion while facing the sealing portion.

In an embodiment of the present disclosure, the at least a portion of the sealing portion may include surfaces including upper and lower surfaces of the sealing portion, and a side surface.

In an embodiment of the present disclosure, the cell pouch may include a first polymer layer, a second polymer layer, and a metal layer interposed between the first polymer layer and the second polymer layer.

In an embodiment of the present disclosure, the metal layer may not be exposed to the outside by the insulator.

In an embodiment of the present disclosure, the insulator may include a first step portion.

In an embodiment of the present disclosure, the insulator may be a film including an insulating material.

In an embodiment of the present disclosure, the film may include a hot melt layer wrapping around the cell pouch while facing it.

In an embodiment of the present disclosure, the insulator may extend continuously from a first end to a second end, a first end of the first insulator may be located on the upper surface of the cell pouch, and a second end of the first insulator may face and be in contact with a surface of the electrode tab.

In an embodiment of the present disclosure, a first end of the second insulator may be located on the upper surface of the cell pouch, and a second end of the second insulator may be located on the lower surface of the cell pouch.

In another embodiment of the present disclosure, the battery cell may further include a sealant portion interposed between the sealing portion and the electrode tab.

In another embodiment of the present disclosure, the sealant portion may include a first sealant region protruding outwardly from the sealing portion.

In another embodiment of the present disclosure, a width of the sealant portion may be larger than a width of the electrode tab.

In another embodiment of the present disclosure, the insulator may be configured to cover the first sealant region.

In another embodiment of the present disclosure, the insulator may further include a second step portion wrapping around at least a portion of the first sealant region while facing and contacting it.

In another embodiment of the present disclosure, the insulator may extend continuously from a first end to a second end, the first end of the insulator may be located on the upper surface of the cell pouch, and the second end of the insulator may face and be in contact with the first surface of the electrode tab.

According to another embodiment of the present disclosure, a method of manufacturing a battery cell includes: preparing an electrode assembly including an electrode tab; covering a portion of the electrode tab with a sealant portion; accommodating the electrode assembly in an accommodation space of a cell pouch and forming a sealing portion by sealing such that a portion of the electrode tab and the sealant portion are exposed to the outside of the cell pouch; disposing an insulating film to cover the sealing portion with an area larger than the size of the sealing portion; and forming an insulator by pressurizing the insulating film.

In another embodiment of the present disclosure, the forming the insulator may be performed by pressurization using a press.

In another embodiment of the present disclosure, the press may include a first step block corresponding to a shape of the sealing portion of the cell pouch, and a second step block corresponding to a shape of a portion of the sealant portion.

In another embodiment of the present disclosure, the press may heat and pressurize an upper surface of the cell pouch and a lower surface on a side opposite to the upper surface.

According to an embodiment of the present disclosure, a battery cell is improved in insulation performance.

According to another embodiment of the present disclosure, a battery cell is improved in durability.

According to still another embodiment of the present disclosure, a method of manufacturing a battery cell is improved in process efficiency.

Meanwhile, a battery cell and a method of manufacturing the same according to the present disclosure may be widely applied to electric vehicles, battery charging stations, and an energy storage system (ESS), and other battery-utilizing fields of green technology such as photovoltaics and wind power.

Furthermore, a battery cell and a method of manufacturing the same according to the present disclosure may also be used in eco-friendly mobility, including electric vehicles and hybrid vehicles to reduce air pollution and greenhouse gas emissions and mitigate climate change.

### BRIEF DESCRIPTION OF THE DRAWINGS

FIG. 1 is a perspective view schematically illustrating a battery cell according to an embodiment of the present disclosure.

FIG. 2 is an exploded perspective view schematically illustrating a battery cell according to an embodiment of the present disclosure.

FIG. 3 is a cross-sectional view of a cell pouch according to an embodiment of the present disclosure.

FIG. 4 is a cross-sectional view of an insulator according to an embodiment of the present disclosure.

FIG. 5 is a cross-sectional view taken along line A-A of FIG. 1.

FIG. 6 is a cross-sectional view taken along line B-B of FIG. 1.

FIG. 7 is a perspective view schematically illustrating a battery cell according to another embodiment of the present disclosure.

FIG. 8 is an exploded perspective view schematically illustrating a battery cell according to another embodiment of the present disclosure.

FIG. 9 is a cross-sectional view taken along line A-A of FIG. 7.

FIG. 10 is a schematic view schematically illustrating a method of manufacturing a battery cell according to another embodiment of the present disclosure.

FIG. 11 is a cross-sectional view schematically illustrating a method of manufacturing a battery cell according to another embodiment of the present disclosure.

FIG. 12 is a schematic view illustrating an insulator being crimped in a method of manufacturing a battery cell according to another embodiment of the present disclosure.

### DETAILED DESCRIPTION

Hereinafter, a battery cell 100 according to an embodiment of the present disclosure and a manufacturing method thereof will be described with reference to the accompanying drawings.

Prior to description, it should be noted that when a portion is said to "include" a component, it means that the portion may further include other components rather than excluding other components, unless specifically noted to the contrary.

In addition, in various embodiments, components having the same configuration will be described by using the same reference numerals in a representative embodiment, while in other embodiments, only components different therefrom will be described.

The structural or functional descriptions of embodiments disclosed in this specification or application are exemplified only for the purpose of describing embodiments in accordance with the technical ideas of the present disclosure, and embodiments in accordance with the technical ideas of the present disclosure may be implemented in various forms other than those disclosed in this specification or application, and the technical ideas of the present disclosure shall not be construed as being limited to the embodiments described in this specification or application.

With reference to the accompanying drawings, the battery cell 100 and the method of manufacturing the same will be described in more detail in accordance with various embodiments of the present disclosure.

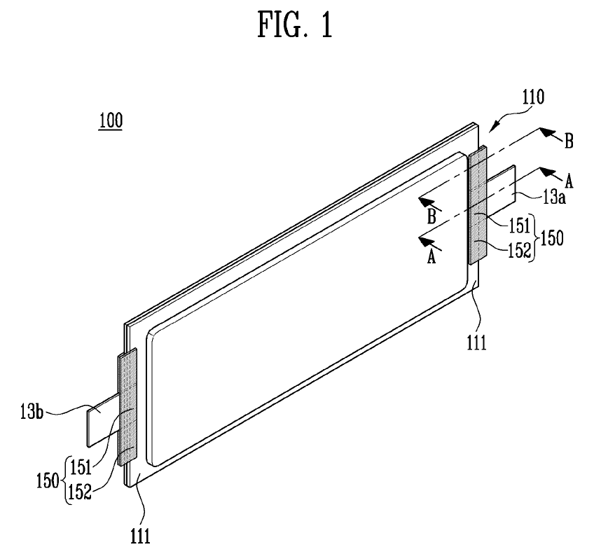

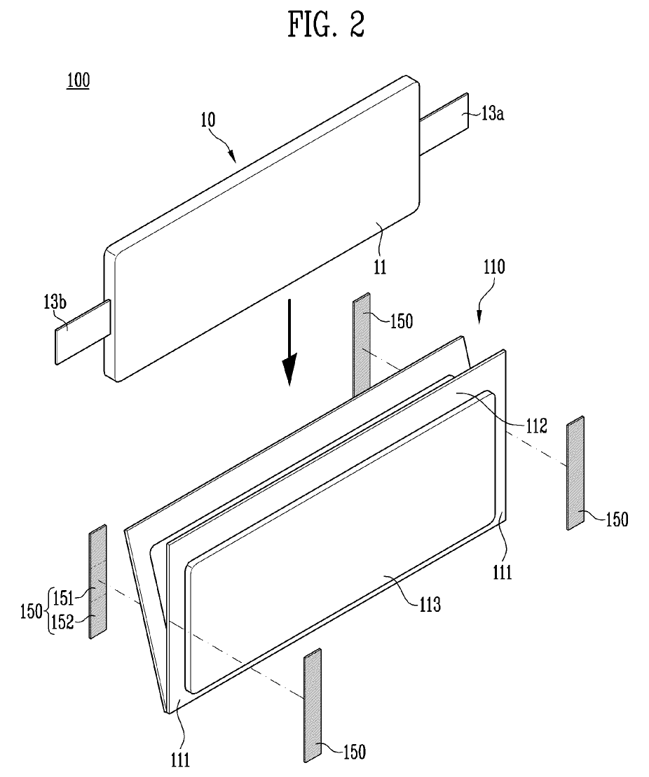

FIG. 1 is a perspective view schematically illustrating a battery cell 100 according to an embodiment of the present disclosure. FIG. 2 is an exploded perspective view schematically illustrating the battery cell 100 according to an embodiment of the present disclosure.

A battery cell 100 according to an embodiment of the present disclosure may include an electrode assembly 10 having one or more electrode tabs 13, a cell pouch 110 accommodating the electrode assembly 10 such that the electrode tabs 13 are led outwardly through sealing portions 111 and 112, and an insulator 150 configured so as to cover at least a portion of the sealing portions 111 and 112. In addition, the insulator 150 includes a first insulator 151 in a region where the electrode tabs 13 are led out, and a second insulator 152 in a region excluding the first insulator 151, and the insulator 150 may wrap around and be in contact with at least a portion of the sealing portions 111 and 112 while facing the sealing portions.

For example, the battery cell 100 may be a secondary battery capable of being charged and discharged a plurality of times. For example, the secondary battery may be one of a lithium cobalt battery, a lithium hi-nickel battery, a lithium iron phosphate battery, a lithium ion battery, a lithium polymer battery, a lithium sulfur battery, a nickel metal hydride battery, a nickel cadmium battery, a sodium battery, an all-solid-state battery, or any other type of secondary battery, but is not limited thereto and may be modified into various types of secondary batteries.

Further, the electrode assembly 10 may include a positive electrode plate, a negative electrode plate, and a separator. The cell pouch 110 for packaging the electrode assembly 10 may be made of a laminate sheet that includes polymer layers 110a and 110c, and a metal layer 110b.

For example, the electrode assembly 10 may include a positive electrode tab 13a and a negative electrode tab 13b. The positive electrode plate and the negative electrode plate may be connected to the positive electrode tab 13a and the negative electrode tab 13b, respectively. The positive electrode tab 13a and the negative electrode tab 13b may be provided as a conductive metal, which may be led out to the outside of the cell pouch 110 described above.

For example, the positive electrode tab 13a and the negative electrode tab 13b may be electrically connected to the electrode assembly 10. The positive electrode tab 13a and negative electrode tab 13b may be provided as a pair. For example, the positive electrode tab 13a and the negative electrode tab 13b may face each other and protrude from both short-side ends of the cell pouch 110.

In an embodiment of the present disclosure, at least a portion of the sealing portions 111 and 112 may include surfaces including the upper and lower surfaces of the sealing portions 111 and 112, and a side surface. Regarding the upper surface and the lower surface of the sealing portions 111 and 112, a surface on which the sealing portion 111 of the cell pouch 110 shown in FIG. 1 is positioned may be described as the upper surface, and a surface opposite to the upper surface may be described as the lower surface. However, the upper and lower surfaces of the sealing portions 111 and 112 may be described in reverse.

For example, the cell pouch 110 may be shaped like a sheet formed with an accommodating space. Thus, the sealing portions 111 and 112 may be thermally fused with the electrode assembly 10 accommodated in the accommodating space. The positive electrode tab 13a and the negative electrode tab 13b led out through the sealing portions 111 and 112 may be connected to a charging and discharging device to perform charging and discharging. For example, the sealing portions 111 and 112 may include first sealing portions 111 at portions where the positive electrode tab 13a and the negative electrode tab 13b are positioned, and a second sealing portion 112 connecting the first sealing portions 111 to each other. For example, the second sealing portion 112 may not be provided with the positive tab 13a and the negative tab 13b.

For example, the cell pouch 110 may accommodate the electrode assembly 10 and an electrolyte together. For example, the electrolyte may include a carbonate-based solvent. For example, the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

For example, the carbonate-based solvent may readily penetrate between polymers having intermolecular spacing, such as polystyrene. Further, for example, the electrolyte may be in a liquid, solid, or gel phase.

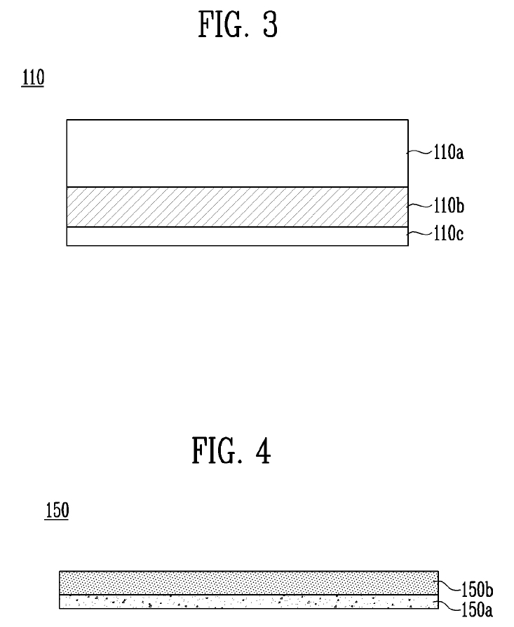

FIG. 3 is a cross-sectional view of a cell pouch 110 according to an embodiment of the present disclosure. FIG. 4 is a cross-sectional view of an insulator 150 according to an embodiment of the present disclosure.

In an embodiment of the present disclosure, the cell pouch 110 may include a first polymer layer 110c, a second polymer layer 110a, and a metal layer 110b interposed between the first polymer layer 110c and the second polymer layer 110a. Further, the metal layer 110b may not be exposed to the outside by the insulator 150.

For example, the cell pouch 110 may be provided in a sheet shape, and the sheet may be formed by sequentially laminating an inner first polymer layer 110c, a metal layer 110b, and an outer second polymer layer 110a. The electrode assembly 10 may be in contact with the inner first polymer layer 110c, and the outer second polymer layer 110a may be provided as an outer surface of the cell pouch 110.

Here, the term ‘inner’ may refer to a direction in which the electrode assembly 10 is positioned relative to the metal layer 110b, and the term ‘outer’ may refer to a direction opposite to the direction in which the electrode assembly 10 is positioned relative to the metal layer 110b, i.e., an outward direction of the battery cell 100.

For example, in the cell pouch 110, the inner first polymer layer 110c may be in direct contact with the electrode assembly 10 or the electrolyte. Further, the inner first polymer layer 110c may be subjected to an electrochemical reaction with the electrode assembly 10, the electrolyte, or the like. Furthermore, the inner first polymer layer 110c may have the sealing portions 111 and 112 formed by thermal fusion, thereby performing a function of sealing the pouch-type battery cell 100.

For example, the inner first polymer layer 110c may include one or more of polypropylene (PP) and cast polypropylene (CPP). Thus, the inner first polymer layer 110c may be configured to function as electrical insulation, while sealing and preventing leakage of the electrolyte and the like.

For example, the metal layer 110b may provide mechanical strength to the cell pouch 110 and maintain the shape of the accommodating space. In addition, the metal layer 110b may prevent moisture, air, and the like from entering and protect the interior of the pouch-type battery cell 100.

For example, the metal layer 110b may utilize an aluminum layer, and in addition to the aluminum layer, the metal layer 110b may utilize various metal materials having the above-described properties. For example, in the case of the aluminum layer, it may be advantageous in that the mechanical strength at a predetermined level or higher can be secured while being light in weight, and it is advantageous in complementing electrochemical properties based on the electrode assembly 10 and the electrolyte and improving heat dissipation, and the like.

For example, the outer second polymer layer 110a may protect the pouch-type battery cell 100 from external shocks, scratches, and the like, and improve mechanical strength. For example, the outer second polymer layer 110a may include polyethylene terephthalate (PET).

Although not shown, the cell pouch 110 may further include an adhesive layer to improve adhesion between the layers. Also, although not shown, the cell pouch 110 may further include a buffer layer interposed between the metal layer 110b and the outer second polymer layer 110a. Such a buffer layer may insulate the metal layer 110b while preventing moisture, air, and the like from entering the interior of the pouch-type battery cell 100. Furthermore, the buffer layer may improve adhesion between the metal layer 110b and the outer second polymer layer 110a. For example, the buffer layer may include nylon or the like.

In an embodiment of the present disclosure, the insulator 150 may include a first step portion 111a. Further, the insulator 150 may be a film including an insulating material, and the film may include a hot melt layer 150a wrapping around the cell pouch 110 while facing it.

For example, at least a portion of the sealing portions 111 and 112 of the cell pouch 110 may be provided with the insulator 150.

For example, the insulator 150 may be provided by spraying, applying, taping, plasma deposition, aluminum anodizing, or the like. Further, the insulator 150 may be at least one selected from the group consisting of a polyester-based resin, a polyolefin-based resin, a polyamide-based resin, and a polycarbonate-based resin.

For example, the insulator 150 may be provided in the sealing portions 111 and 112, specifically in the portion from which the positive electrode tab 13a or the negative electrode tab 13b is led out.

For example, the hot melt layer 150a may serve to maintain the insulating film 150b adhered to an adherend portion of the battery cell 100. For example, the hot melt layer 150a may be pre-included in the insulating film 150b and adhered to the battery cell 100 as one film, or the hot melt layer 150a may be a separate layer from the insulating film 150b so that the insulating film 150b may be attached thereon after the hot melt layer 150a is adhered to the battery cell 100.

For example, the hot melt layer 150a may be made of a polyolefin-based resin including polyethylene and polypropylene, a thermoplastic resin including ethylene vinyl acetate, polyester, and polyamide, or a thermosetting resin including polyurethane-based resin.

As described above, because the battery cell 100 is sealed by thermally melting the first polymer layer 110c, the melting point of the hot melt layer 150a should be lower than the melting point of the first polymer layer 110c to avoid affecting the performance of the first polymer layer 110c.

On the other hand, when the thickness of the hot melt layer 150a increases, a problem may arise in that the heating temperature required to melt the hot melt layer 150a and impart fluidity thereto also increases, which may adversely affect the first polymer layer 110c that performs the sealing. Therefore, the first polymer layer 110c may be set to a thickness of 12 μm to 50 μm, and the hot melt layer 150a may be set to a thickness of 25 μm to 125 μm. When the first polymer layer 110c and the hot melt layer 150a fall outside the thickness range described above, the adhesion performance of the hot melt layer 150a may be deteriorated, and a lifting phenomenon may occur from an object to be insulated even though the insulating film 150b is attached.

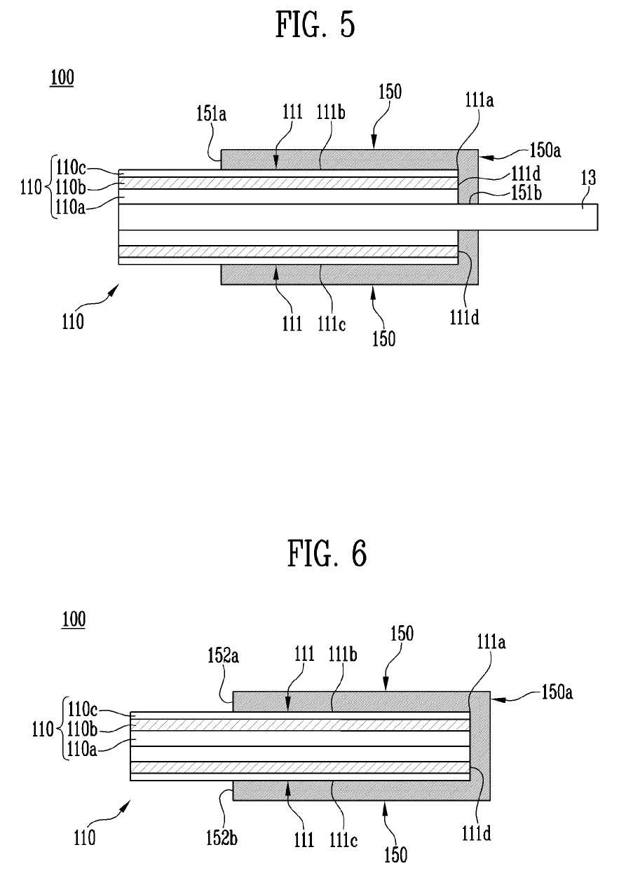

FIG. 5 is a cross-sectional view taken along line A-A of FIG. 1. FIG. 6 is a cross-sectional view taken along line B-B of FIG. 1.

According to an embodiment of the present disclosure, the insulator 150 may extend continuously from a first end to a second end, in which a first end 151a of the first insulator 151 is located on an upper surface 111b of the cell pouch 110, and a second end 151b of the first insulator 151 may face and contact the upper surface of the electrode tab 13. Here, the upper surface and lower surface of the cell pouch 110 may be described by referring to a surface on which the sealing portion 111 of the cell pouch 110 shown in FIG. 1 is located as the upper surface, and a surface opposite to the upper surface as the lower surface. However, the upper surface and lower surface of the cell pouch 110 may also be described in reverse.

Further, according to an embodiment of the present disclosure, a first end 152a of the second insulator 152 may be located on the upper surface 111b of the cell pouch 110, and a second end 152b of the second insulator 152 may be located on the lower surface of the cell pouch 110.

For example, the cell pouch 110 may be manufactured through a cutting process, by which the metal layer 110b formed between the first polymer layer 110c and the second polymer layer 110a at a short-side end of the pouch may be exposed to the outside.

For example, an electrical connection may occur between the laterally exposed metal layer 110b and the positive electrode tab 13a or the negative electrode tab 13b when unintended moisture or impurities are interposed between the metal layer 110b and the positive electrode tab 13a or the negative electrode tab 13b. For example, when an electrical connection occurs between the metal layer 110b and the positive electrode tab 13a or the negative electrode tab 13b, a potential difference between the metal layer 110b and the positive electrode tab 13a or negative electrode tab 13b may cause corrosion of the metal layer 110b.

Additionally, even when the short-side ends of the cell pouch 110 adjacent to the positive electrode tab 13a or negative electrode tab 13b are bent, for example, due to shock or vibration during the manufacturing process of the battery cell 100, the short-side ends of the cell pouch 110 may also come into contact with the positive electrode tab 13a or the negative electrode tab 13b. In such a case, an electrical connection may occur between the metal layer 110b and the positive electrode tab 13a or negative electrode tab 13b, and the potential difference between the metal layer 110b and the positive electrode tab 13a or negative electrode tab 13b may cause corrosion of the metal layer 110b.

Therefore, the first insulator 151 or the second insulator 152 may be formed at the end of the metal layer 110b to electrically insulate the end of the metal layer 110b of the cell pouch 110.

For example, the first insulator 151 and the second insulator 152 may be in the form of a film including at least one insulating materials selected from the group consisting of a polyester-based resin, a polyolefin-based resin, a polyamide-based resin, and a polycarbonate-based resin.

Further, a surface of such a film, specifically, a surface in a direction facing the cell pouch 110, may include a hot melt layer 150a. For example, the hot melt layer 150a is a layer having an adhesive component, which may be an adhesive made using a thermoplastic resin. As described above, the hot melt layer 150a is melted by heat, applied to an adherend, and then solidified upon cooling to exhibit adhesion. Thus, the film-shaped first insulator 151 or second insulator 152 may be easily bonded to the cell pouch 110. Thus, difficulty in disposing the first insulator 151 and the second insulator 152 on the short-side ends of the cell pouch 110 can be reduced.

For example, it is preferred that the film including the hot melt layer 150a has a melting point lower than the melting point of the first polymer layer 110c or the second polymer layer 110a of the cell pouch 110. For example, when the melting point of the film including the hot melt layer 150a is higher than the melting point of the first polymer layer 110c or second polymer layer 110a, the sealing of the battery cell 100 may be affected.

For example, as shown in FIG. 5, the first insulator 151 may wrap around the short-side end of the cell pouch 110 in a direction toward the positive electrode tab 13a or the negative electrode tab 13b to insulate the end of the metal layer 110b. Furthermore, as shown in FIG. 6, the second insulator 152 may insulate the end of the metal layer 110b by wrapping around the short-side end of the cell pouch 110 in a portion where the positive electrode tab 13a or the negative electrode tab 13b is not located.

Specifically, the first insulator 151 may be formed extending from the first end 151a to the second end 151b, in which the first end 151a of the first insulator 151 is located in a region of the upper surface 111b of the cell pouch 110, and the second end 151b of the first insulator 151 may face and be in contact with the surface of the positive electrode tab 13a or the negative electrode tab 13b.

Further, the first insulator 151 may be changed in its extending direction as being bent approximately perpendicularly to form the first step portion 111a at a corner portion where the upper surface 111b and a side surface 111d of the cell pouch 110 meet. Thus, the first insulator 151 may enclose and cover the upper and side surfaces of the sealing portions 111 and 112. Furthermore, because the first insulator 151 is in contact with a portion of the sealing portions 111 and 112 while facing and wrapping around the portion of the sealing portions 111 and 112, the upper surface and side surface of the sealing portions 111 and 112 may not be exposed to the outside, and no space may be present between the portion of the sealing portions 111 and 112 and the first insulator 151.

On the other hand, the second insulator 152 may also be formed extending from a first end 152a to a second end 152b, in which the first end 152a of the second insulator 152 may be located in a region of the upper surface 111b of the cell pouch 110, and the second end 152b of the second insulator 152 may be located in a region of the lower surface 111b of the cell pouch 110. For example, the second insulator 152 located at a portion excluding a position corresponding to the positive electrode tab 13a or the negative electrode tab 13b of the cell pouch 110 may be formed as a single unit.

Furthermore, because the second insulator 152 encloses and covers all of the upper, side and lower surfaces of the sealing portions 111 and 112, and is in contact with a portion of the sealing portions 111 and 112 while facing and wrapping around that portion of the sealing portions 111 and 112, the upper, side and lower surfaces of the sealing portions 111 and 112 are not exposed to the outside, and no space may be present between the portion of the sealing portions 111 and 112 and the second insulator 152.

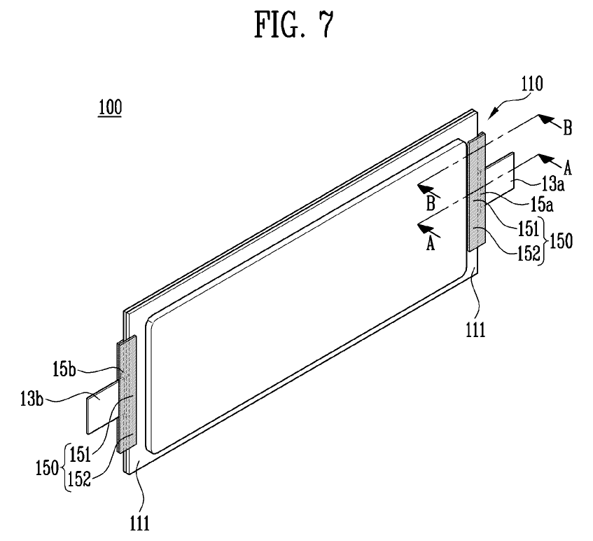

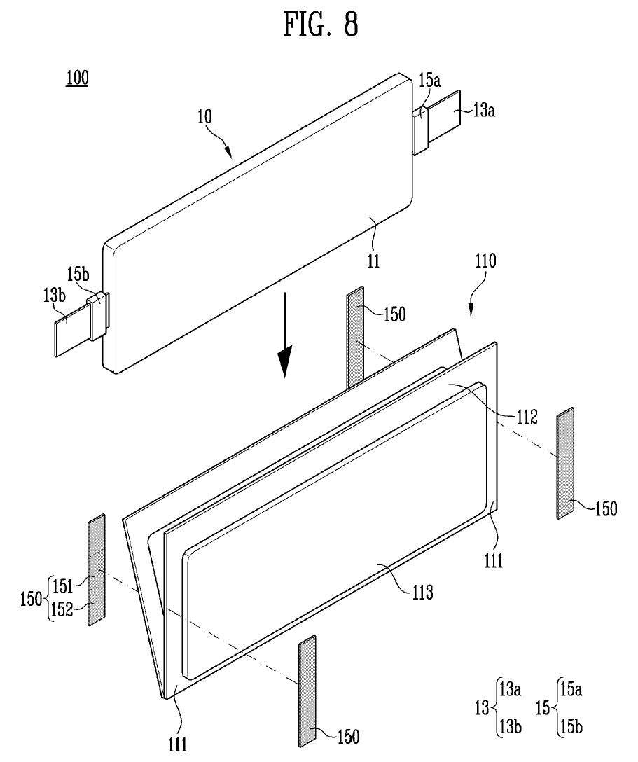

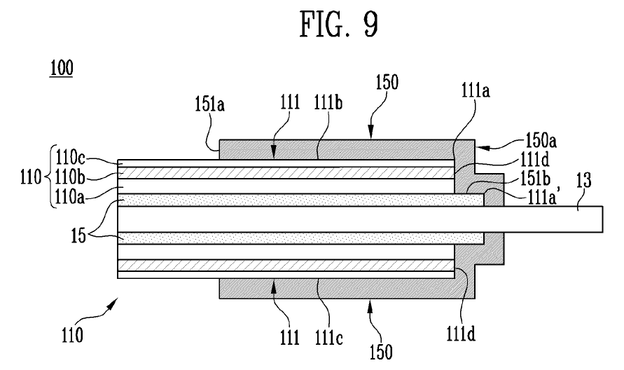

FIG. 7 is a perspective view schematically illustrating a battery cell 100 according to another embodiment of the present disclosure. FIG. 8 is an exploded perspective view schematically illustrating the battery cell 100 according to another embodiment of the present disclosure. FIG. 9 is a cross-sectional view taken along line A-A of FIG. 7.

According to this embodiment of the present disclosure, the battery cell 100 may further include a sealant portion 15 interposed between the sealing portions 111 and 112 and the electrode tab 13. For example, the sealant portion 15 may include a first sealant portion 15a protruding outwardly from the sealing portions 111 and 112.

For example, the battery cell 100 according to this embodiment of the present disclosure may include the sealant portion 15 interposed between the cell pouch 110 and the electrode tabs 13, as shown in FIGS. 7-9.

For example, during a process of sealing the cell pouch 110, the sealant portion 15 may provide additional adhesion so that the cell pouch 110 and the electrode tab 13 are sufficiently bonded to each other.

For example, the inner first polymer layer 110c of the cell pouch 110 may be made of a polymer material to secure insulation and adhesion, and the electrode tab 13 may be made of a metal material to secure electrical conductivity, making it not easy to completely adhere the cell pouch 110 and the electrode tab 13 to each other.

Therefore, the sealant portion 15 may improve adhesion between the inner first polymer layer 110c of the cell pouch 110 and the positive electrode tab 13a or the negative electrode tab 13b formed of different materials, while preventing the cell pouch 110 from being damaged by the positive electrode tab 13a or the negative electrode tab 13b.

In another embodiment of the present disclosure, the width of the sealant portion 15 may be larger than the width of the electrode tab 13. For example, the sealant portion 15 may be formed of a non-conductive material that does not conduct electricity. For example, the sealant portion 15 may be provided in a film shape to wrap around the positive electrode tab 13a or the negative electrode tab 13b. For example, the sealant portion 15 may be provided in a polymer resin form so as to coat the outer surface of the positive electrode tab 13a or the negative electrode tab 13b.

For example, the sealant portion 15 may be made of at least one selected from the group consisting of polyethylene, polyacetylene, PTFE, nylon, polyacetylene, polyimide, polyethylene terephthalate, and polypropylene.

In another embodiment of the present disclosure, the insulator 150 may cover the first sealant portion 15a and may further include a second step portion 111a’ wrapping around at least a portion of the first sealant portion 15a while facing and contacting it. Specifically, the insulator 150 may be formed extending continuously from the first end to the second end, wherein the first end of the insulator 150 is located a region of the upper surface 111b of the cell pouch 110, and the second end of the insulator 150 may face and be in contact with a first surface of the electrode tab 13.

For example, as shown in FIG. 9, the insulator 150 may also cover the first sealant region. Specifically, the insulator 150 may be formed extending from the first end to the second end, in which the first end of the insulator 150 is located in a region of the upper surface 111b of the cell pouch 110, and the second end of the insulator 150 may be face and be in contact with the surface of the positive electrode tab 13a or the negative electrode tab 13b.

As shown in FIG. 9, the sealant portion 15 is interposed between the cell pouch 110 and the electrode tab 13, and because the first sealant portion 15a protrudes outwardly from the sealing portions 111 and 112, an additional step shape corresponding to the thickness of the sealant portion 15 may be formed.

Thus, when the insulator 150 extends from its first end, it may be bent in its extending direction approximately perpendicular to form the first step portion 111a at a corner portion where the upper surface 111b and the side surface 111d of the cell pouch 110 meet. Furthermore, the extending direction of the insulator 150 may be changed as being bent approximately perpendicularly to form a second step portion 111a’ at a corner portion where the upper surface and the side surface of the region of the first sealant portion 15a meet.

Thus, the insulator 150 may enclose and cover the upper surface and side surface of the sealing portions 111 and 112 while simultaneously enclosing and covering the upper surface and side surface of the first sealant portion 15a region. Furthermore, because the insulator 150 faces and is in contact with a portion of the sealing portions 111 and 112 and the first sealant region by wrapping around them, the upper surface and side surface of the sealing portions 111 and 112 and the upper surface and side surface of the first sealant region 15a may not be exposed to the outside, no space may be present between the portion of the sealing portions 111 and 112 and the insulator 150, and between the first sealant region and the insulator 150.

For example, in the embodiment shown in FIG. 9, the insulator 150 is positioned beyond the sealant portion 15 in the direction facing the electrode tab 13. In this case, by covering a large area with the insulating film 150b, it is possible to prevent the insulating film 150b from being lifted from the adherend due to a repulsive force of the insulating film 150b. Furthermore, because the insulating film 150b has predetermined stiffness, a welded portion of the electrode tab 13 may be prevented from bending during a subsequent manufacturing process of the battery module.

For example, although not shown, it is possible for the insulator 150 to be formed only up to the sealant portion 15 in the direction facing the electrode tab 13. Even in this case, while the insulator 150 is prevented from affecting the electrode tab 13, the insulator 150 is not damaged by foreign substances or temperatures that may be generated in the manufacturing process of the battery module.

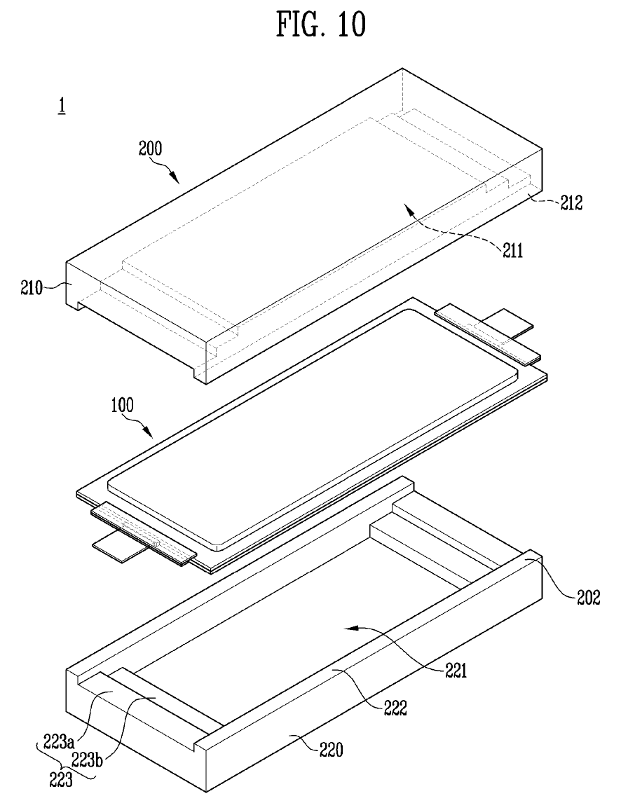

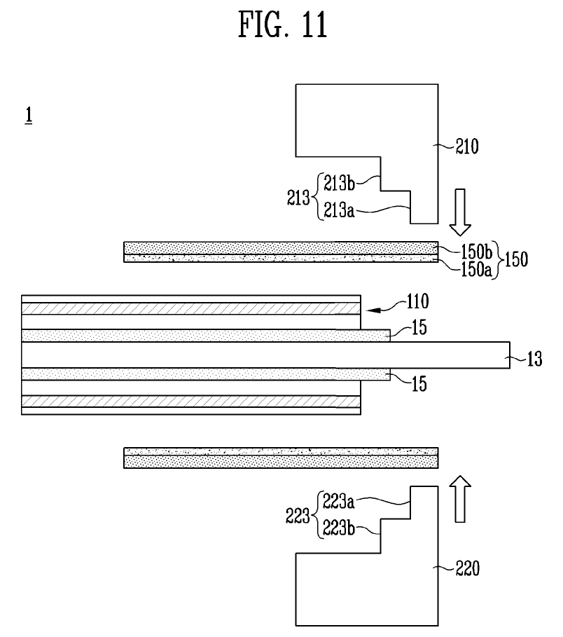

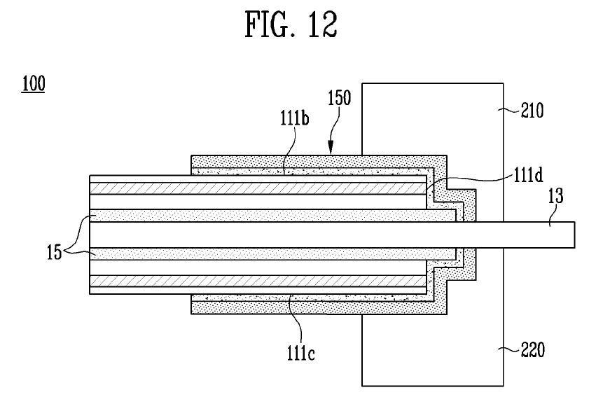

FIG. 10 is a schematic view schematically illustrating a method of manufacturing a battery cell 100 according to another embodiment of the present disclosure. FIG. 11 is a cross-sectional view schematically illustrating a method of manufacturing a battery cell 100 according to another embodiment of the present disclosure. FIG. 12 is a schematic view illustrating an insulator 150 being crimped in a method of manufacturing a battery cell 100 according to another embodiment of the present disclosure.

According to this embodiment of the present disclosure, a method of manufacturing the battery cell 100 may be provided.

For example, the method of manufacturing the battery cell 100 may include preparing the battery cell 100 in which the sealant portion 15 is formed. Next, the aforementioned insulator 150 may be formed by disposing an insulating film 150b large enough to cover both the sealing portions 111 and 112 of the battery cell 100 and the sealant portion 15 protruding outwardly of the sealing portions 111 and 112, and then pressing the insulating film 150 from upper and lower sides through a press mold.

In another embodiment of the present disclosure, step of forming the insulator 150 may be performed by pressurizing with a press 200.

For example, as shown in FIG. 10, the press 200 may include a mold that includes an upper mold 210 and a lower mold 220.

For example, the upper mold 210 and the lower mold 220 may include an upper recessed portion 211 and a lower recessed portion 221 provided in a shape corresponding to the shape of the battery cell 100, respectively. For example, in the upper mold 210 and the lower mold 220, an upper support portion 212 and a lower support portion 222 may be disposed in portions where the upper depression 211 and the lower depression 221 are not provided.

In another embodiment of the present disclosure, the press 200 may include a first step block 223b corresponding to a shape of the sealing portions 111 and 112 of the cell pouch 110 and a second step block 223a corresponding to a shape of a portion of the sealant portion 15.

For example, the upper mold 210 and the lower mold 220 may include a first step block 223b corresponding to a shape of the upper surface and side surface of the sealing portions 111 and 112 of the cell pouch 110 to be pressurized. Further, the upper mold 210 and the lower mold 220 may include a second step block 223a corresponding to a shape of the upper surface and side surface of the sealant portion 15 of the cell pouch 110 to be pressurized.

For example, the battery cell 100 and the insulating film 150b large enough to cover the battery cell 100 may be disposed at the upper and lower portions of the battery cell 100, and after disposing the battery cell 100 and the insulating film 150b in the space formed between the upper recessed portion 211 and the lower recessed portion 221, the upper mold 210 and the lower mold 220 are moved to pressurize the upper and lower portions.

At this time, the insulating film 150b may be disposed in two pieces on each side of the cell pouch 110 in a size that can cover the sealing portions 111 and 112 and the sealant portion 15 on both sides of the battery cell 100. For example, a single insulating film 150b may be formed in a size that can cover from the sealant portion 15 on one side of the battery cell 100 to the sealant portion 15 on the other side of the battery cell 100.

Furthermore, because the first step block 223b and the second step block 223a are formed in the upper mold 210 and the lower mold 220, respectively, in a shape corresponding to one side of the battery cell 100, the insulating film 150b may be folded or bent accordingly to wrap around the upper and lower surfaces and both lateral sides of the battery cell 100 upon pressurizing of the press 200.

For example, when the pressurization with the upper mold 210 and the lower mold 220 formed in a simple planar structure is performed, the shape of the face-to-face wrapping insulator 150 described above cannot be formed. Therefore, when forming the insulator 150, it is necessary to cover a large area with an adhesive, which may cause a problem of increasing the thickness of the adhesive. However, with the first step block 223b and the second step block 223a according to another embodiment of the present disclosure, it is possible to form the shape of the aforementioned insulator 150, which is a structure having a step, and reduce the covering area and thickness of the adhesive.

In another embodiment of the present disclosure, the press 200 may perform the pressurization by mutually heating and pressurizing the upper surface 111b of the cell pouch 110 and the lower surface located on a side opposite to the upper surface 111b.

For example, because the insulating film 150b includes the hot melt layer 150a in a direction facing the battery cell 100, the press 200 preferably performs the pressurization while heating to a predetermined temperature or higher in order to melt and adhere the hot melt layer 150a to the battery cell 100.

For example, the temperature of the press 200 may be set at a level about 20° C higher than the melting point of the materials constituting the hot melt layer 150a, and the press 200 may perform the pressurization at a pressure of about 0.2 MPa to about 1 MPa for about 5 seconds or more to improve the adhesion area and adhesion while maintaining the shape of the aforementioned insulator 150.

Referring to the foregoing description, it will be understood by those skilled in the art to which the present disclosure belongs that the present disclosure may be practiced in other specific forms without changing the technical spirit or essential features of the present disclosure.

Therefore, it should be understood that the embodiments described above are exemplary in all respects and are not intended to limit the present disclosure to the foregoing embodiments, and the scope of the present disclosure is indicated by the appended claims, and all modifications or modified forms derived from the meaning and scope of the claims and their equivalent concept are to be construed as being included within the scope of the present disclosure.

What is claimed is:

1. A battery cell comprising:
an electrode assembly comprising at least one electrode tab;
a cell pouch configured to accommodate the electrode assembly such that the electrode tab is led out to the outside through a sealing portion; and
an insulator configured to cover at least a portion of the sealing portion, wherein
the insulator comprises a first insulator in a region where the electrode tab is led out, and a second insulator in a remaining region excluding the first insulator, and
the insulator wraps around and is in contact with at least a portion of the sealing portion while facing the sealing portion.

2. The battery cell of claim 1, wherein the at least a portion of the sealing portion comprises surfaces comprising upper and lower surfaces of the sealing portion, and a side surface.

3. The battery cell of claim 1, wherein the cell pouch comprises a first polymer layer, a second polymer layer, and a metal layer interposed between the first polymer layer and the second polymer layer.

4. The battery cell of claim 3, wherein the metal layer is not exposed to the outside by the insulator.

5. The battery cell of claim 2, wherein the insulator comprises a first step portion.

6. The battery cell of claim 2, wherein the insulator is a film comprising an insulating material.

7. The battery cell of claim 6, wherein the film comprises a hot melt layer wrapping around the cell pouch while facing it.

8. The battery cell of claim 2, wherein
the insulator extends continuously from a first end to a second end,
a first end of the first insulator is located on the upper surface of the cell pouch, and
a second end of the first insulator faces and is in contact with a surface of the electrode tab.

9. The battery cell of claim 8, wherein
a first end of the second insulator is located on the upper surface of the cell pouch, and
a second end of the second insulator is located on the lower surface of the cell pouch.

10. The battery cell of claim 1, further comprising a sealant portion interposed between the sealing portion and the electrode tab.

11. The battery cell of claim 10, wherein the sealant portion comprises a first sealant region protruding outwardly from the sealing portion.

12. The battery cell of claim 10, wherein a width of the sealant portion is larger than a width of the electrode tab.

13. The battery cell of claim 12, wherein the insulator is configured to cover the first sealant region.

14. The battery cell of claim 13, wherein the insulator further comprises a second step portion wrapping around at least a portion of the first sealant region while facing and contacting it.

15. The battery cell of claim 14, wherein
the insulator extends continuously from a first end to a second end,
the first end of the insulator is located on the upper surface of the cell pouch, and
the second end of the insulator faces and is in contact with the first surface of the electrode tab.

16. A method of manufacturing a battery cell, the method comprising:
preparing an electrode assembly comprising an electrode tab;
covering a portion of the electrode tab with a sealant portion;
accommodating the electrode assembly in an accommodation space of a cell pouch and forming a sealing portion by sealing such that a portion of the electrode tab and the sealant portion are exposed to the outside of the cell pouch;
disposing an insulating film to cover the sealing portion with an area larger than the size of the sealing portion; and
forming an insulator by pressurizing the insulating film.

17. The method of claim 16, wherein the forming the insulator is performed by pressurization using a press.

18. The method of claim 17, wherein the press comprises a first step block corresponding to a shape of the sealing portion of the cell pouch, and a second step block corresponding to a shape of a portion of the sealant portion.

19. The method of claim 18, wherein the press heats and pressurizes an upper surface of the cell pouch and a lower surface on a side opposite to the upper surface.
